(19) United States
(12) Patent Application Publication
(10) Pub. No.: US 2006/0242819 A1
(43) Pub. Date: Nov. 2, 2006

(54) Chuck with improved sleeve

(75) Inventor: Theodore G. Yaksich, Seneca, SC (US)

Correspondence Address: NELSON MULLINS RILEY & SCARBOROUGH, LLP, 1320 MAIN STREET, 17TH FLOOR, COLUMBIA, SC, 29201, US

(73) Assignee: Jacobs Chuck Manufacturing Company

(21) Appl. No.: 11/410,779

(22) Filed: Apr. 25, 2006

Related U.S. Application Data
(62) Division of application No. 11/109,053, filed on Apr. 19, 2005.

(51) Int. Cl. B23P 17/04

(52) U.S. Cl. 29/592

(57) ABSTRACT

A chuck includes a body, a plurality of jaws slidably positioned in the body, a nut coupled to the jaws so that rotational movement of the nut with respect to the body causes the jaws to move toward or away from an axial bore formed in the body, and a sleeve having a generally cylindrical inner core having an outer circumferential surface. The inner core is formed from a rigid polymer. An outer skin is adhered to the inner core outer circumferential surface. The inner core is mounted about the body in operative engagement with the nut so that rotation of the inner core with respect to the body causes the jaws to reciprocate relative to the body.

This application is a divisional of U.S. patent application Ser. No. 11/109,053, the entire disclosure of which is incorporated by reference herein.

### FIELD OF THE INVENTION

The present invention relates generally to chucks for use with drills or with electric or pneumatic power drivers. More particularly, the present invention relates to a chuck of the keyless type which may be tightened or loosened by hand or actuation of the driver motor.

### BACKGROUND OF THE INVENTION

Hand, electric and pneumatic tool drivers are well known. Although twist drills are the most common tools on such drivers, the tools may also comprise screw drivers, nut drivers, burrs, mounted grinding stones, and other cutting or abrading tools. Since the tool shanks may be of varying diameter or of polygonal cross section, the device is usually provided with a chuck adjustable over a relatively wide range. The chuck may be attached to the driver by a threaded or tapered bore.

A variety of chucks have been developed in the art. In an oblique jawed chuck, a chuck body includes three passageways disposed approximately 120 degrees apart from each other. The passageways are configured so that their center lines meet at a point along the chuck axis forward of the chuck. The passageways constrain three jaws that are moveable in the passageways to grip a cylindrical or polygonal tool shank displaced approximately along the chuck center axis. The chuck includes a nut that rotates about the chuck center and that engages threads on the jaws so that rotation of the nut moves the jaws in either direction within the passageways. The body is attached to the drive shaft of a driver and is configured so that rotation of the body in one direction with respect to the nut forces the jaws into gripping relationship with the tool shank, while rotation in the opposite direction releases the gripping relationship. The chuck may be keyless if it is rotated by hand. Various configurations of keyless chucks are known in the art and are desirable for a variety of applications.

### SUMMARY OF THE INVENTION

The present invention recognizes and addresses considerations of prior art constructions and methods. In one preferred embodiment, a method is disclosed for manufacturing a chuck for use with a manual or powered driver having a rotatable drive shaft. A body is provided having a nose section and a tail section, the tail section being configured to matingly attach to the drive shaft for rotation therewith, and the nose section having an axial bore formed therein and a plurality of angularly disposed passageways formed therethrough and intersecting the axial bore. A plurality of jaws are slidably positioned in respective ones of the angularly disposed passageways. A nut is coupled to the jaws so that rotational movement of the nut with respect to the body causes the jaws to move toward or away from the axial bore depending on the direction of rotational movement. A generally cylindrical inner core is molded from a rigid polymer. An outer core is molded, about an outer circumferential surface of the inner core, from a resilient polymer so that material comprising the outer skin commingles with material comprising the inner core. The outer skin has a radial thickness, and the molding step includes varying the radial thickness of the outer skin according to a predetermined pattern. The inner core is disposed about the body in operative engagement with the nut so that the outer skin defines an outer gripping surface of the chuck and so that rotation of the inner core with respect to the body causes the jaws to reciprocate relative to the body.

In another embodiment of a method according to the present invention, a body is provided having a nose section and a tail section, the tail section being configured to matingly attach to the drive shaft for rotation therewith, and the nose section having an axial bore formed therein and a plurality of angularly disposed passageways formed therethrough and intersecting the axial bore. A plurality of jaws are slidably positioned in respective ones of the angularly disposed passageways. A nut is coupled to the jaws so that rotational movement of the nut with respect to the body causes the jaws to move toward or away from the axial bore depending on the direction of rotational movement. A generally cylindrical rigid polymer inner core is molded and has an axial first end and an axial second end. A resilient polymer outer skin is molded about an outer circumferential surface of the inner core rearward of the inner core first end. The outer skin adheres to the inner core, and a portion of the outer circumferential surface of the inner core adjacent the first end is not covered by the outer skin. The inner core is disposed about the body in operative engagement with the nut so that the outer skin defines an outer gripping surface of the chuck and so that rotation of the inner core with respect to the body causes the jaws to reciprocate relative to the body.

In a further embodiment, a body is provided having a nose section and a tail section, the tail section being configured to matingly attach to the drive shaft for rotation therewith, and the nose section having an axial bore formed therein and a plurality of angularly disposed passageways formed therethrough and intersecting the axial bore. A plurality of jaws are slidably positioned in respective ones of the angularly disposed passageways. A nut is coupled to the jaws so that rotational movement of the nut with respect to the body causes the jaws to move toward or away from the axial bore depending on the direction of rotational movement. A generally cylindrical rigid polymer inner core is molded and has an outer circumferential surface and at least one predetermined raised portion extending therefrom. A resilient polymer outer skin is molded about the outer circumferential surface of the inner core so that the resilient polymer outer skin covers the outer circumferential surface but does not cover the predetermined raised portion. The inner core is disposed about the body in operative engagement with the nut so that the outer skin defines an outer gripping surface of the chuck and so that rotation of the inner core with respect to the body causes the jaws to reciprocate relative to the body.

In yet another embodiment, a chuck for use with a manual or powered driver that has a rotatable drive shaft comprises a body having a nose section and a tail section, the tail section being configured to matingly attach to the drive shaft for rotation therewith, and the nose section having an axial bore formed therein and a plurality of angularly disposed passageways formed therethrough and intersecting the axial bore. A plurality of jaws are slidably positioned in respective ones of the angularly disposed passageways. A nut is coupled to the jaws so that rotational movement of the nut with respect to the body causes the jaws to move toward or away from the axial bore depending on the direction of rotational movement. A sleeve has a generally cylindrical inner core having an outer circumferential surface and is formed from a rigid polymer. The sleeve also has an outer skin adhered to the outer circumferential surface of the inner core and that is formed from a resilient polymer having a hardness less than about 80 Shore A units. The inner core is disposed about the body in operative engagement with the nut so that rotation of the inner core with respect to the body causes the jaws to reciprocate relative to the body.

In another embodiment, a chuck has a body having a nose section and a tail section, the tail section being configured to matingly attach to the drive shaft for rotation therewith, and the nose section having an axial bore formed therein and a plurality of angularly disposed passageways formed therethrough and intersecting the axial bore. A plurality of jaws are slidably positioned in respective ones of the angularly disposed passageways. A nut is coupled to the jaws so that rotational movement of the nut with respect to the body causes the jaws to move toward or away from the axial bore depending on the direction of rotational movement. A sleeve has a generally cylindrical inner core having an axial first end and an axial second end and defining an outer circumferential surface. The inner core is formed from a rigid polymer. The sleeve also has an outer skin of a resilient polymer adhered to the outer circumferential surface of the inner core and having a radial thickness that varies in a predetermined pattern to form a gripping surface. The outer skin substantially covers the outer circumferential surface of the inner core but does not cover a portion of the outer circumferential surface of the inner core adjacent the first end. The inner core is disposed about the body in operative engagement with the nut so that rotation of the inner core with respect to the body causes the jaws to reciprocate relative to the body.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is an exploded view of a chuck in accordance with an embodiment of the present invention;

FIG. 2 is a longitudinal view, in cross section, of the chuck shown in FIG. 1;

FIG. 3A is a partially exploded perspective view of the chuck shown in FIG. 1;

FIG. 3B is a partially exploded perspective view of the chuck shown in FIG. 1;

FIG. 4 is an exploded view of a chuck in accordance with an embodiment of the present invention;

FIG. 5 is a longitudinal view, in cross section, of the chuck shown in FIG. 4; and

FIG. 6 is a cross-sectional perspective view of the sleeve shown in FIG. 1.

Repeat use of reference characters in the present specification and drawings is intended to represent same or analogous features or elements of the invention.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

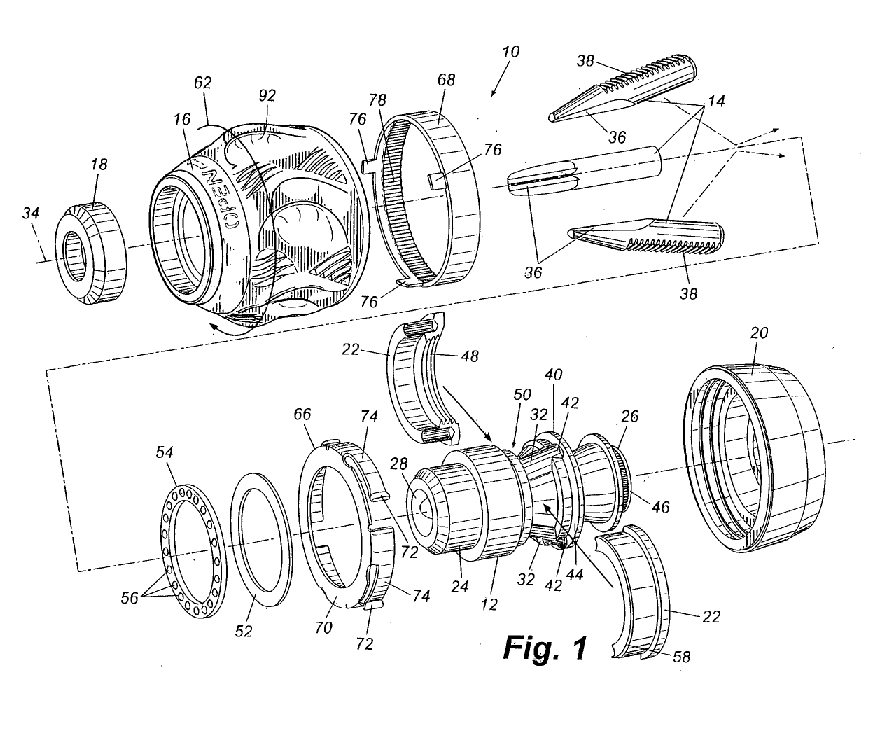

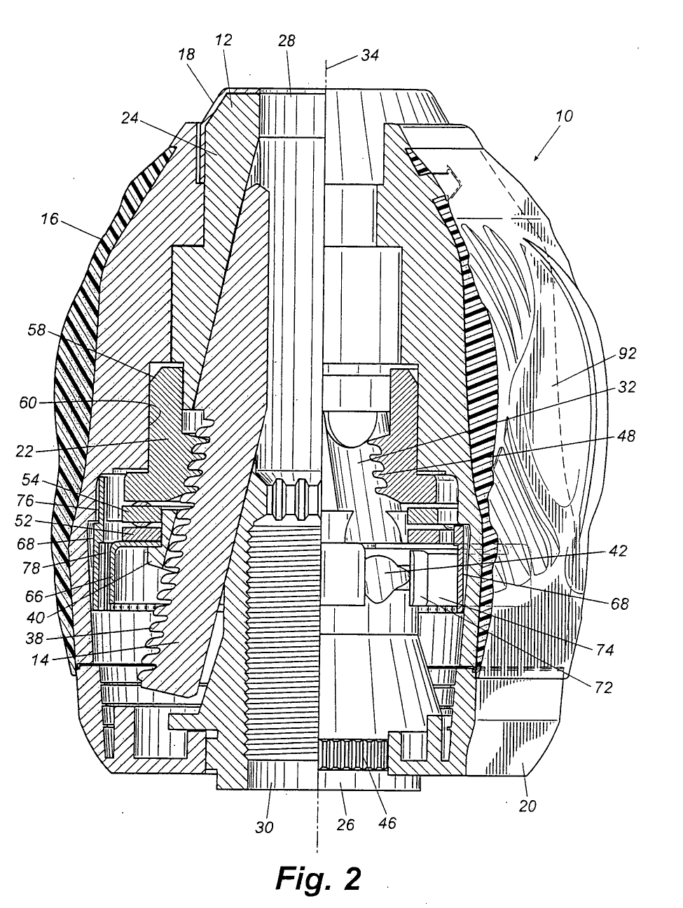

Referring to FIGS. 1 and 2, a chuck 10 in accordance with the present invention includes a body 12, three jaws 14, a front sleeve 16, a nose piece 18, a rear ring 20 and a nut 22. Body 12 is generally cylindrical in shape and comprises a nose or forward section 24 and a tail or rearward section 26. An axial bore 28 formed in forward section 24 is dimensioned somewhat larger than the largest tool shank that chuck 10 is designed to accommodate. A threaded bore 30 (FIG. 2) is formed in tail section 26 and is of a standard size to mate with a drive shaft of a powered or hand driver, for example a power drill having a spindle. The bores 28 and 30 may communicate at a central region of body 12. While a threaded bore 30 is illustrated, the bore is interchangeable with a tapered bore of a standard size to mate with a tapered drive shaft. Furthermore, body 12 may be formed integrally with the drive shaft.

Body 12 also defines three passageways 32 that accommodate jaws 14. Each jaw is separated from each adjacent jaw by an arc of approximately 120 degrees. The axis of passageways 32 and jaws 14 are angled with respect to the chuck center axis 34 such that each passageway axis travels through axial bore 28 and intersects axis 34 at a common point. Each jaw 14 has a tool engaging face 36 generally parallel to chuck axis 34 and threads 38 formed on the jaw's opposite or outer surface that may be constructed in any suitable type and pitch.

Body 12 includes a thrust ring member 40 which, in a preferred embodiment, may be integral with body 12. In an alternate embodiment, thrust ring member 40 may be a separate component from body 12 that is axially and rotationally fixed to the chuck body by interlocking tabs, press fitting or other suitable connection means. Thrust ring member 40 includes a plurality of jaw guide ways 42 formed around its circumference to permit retraction of jaws 14 therethrough and also includes a ledge portion 44 to receive a bearing assembly as described below.

Body tail section 26 includes a knurled surface 46 that receives rear ring 20 in a press fit fashion. Rear ring 20 could also be retained through a press fit without knurling, by use of a key or by crimping, staking, riveting, threading or any other suitable method of securing the sleeve to the body. Further, the chuck may be constructed with a single sleeve having no rear sleeve, for example where the power driver to which the chuck is attached includes a spindle lock feature to enable actuation of the chuck by the single sleeve when the spindle is rotationally fixed by the spindle lock.

Nut 22, which in the illustrated embodiment is a split nut, defines female threads 48 located on an inner circumference of the nut and is received in a groove 50 formed in chuck body 12 proximate thrust ring member 40. A bearing washer 52 and an annular bearing cage 54 are received between thrust ring 42 and nut 22. Bearing cage 54 holds a plurality of balls 56 that permits the nut to rotate relative to the chuck body.

Nut 22 is shown in FIG. 1 without serrations or knurling on its outer circumference. However, it should be understood that nut 22 may be formed with axially-aligned teeth, or other forms of knurling, on its outer circumference, and its outer edges may be provided with a small chamfer 58 to facilitate press fitting of the nut into a bore 60 (FIG. 2) of front sleeve 16. Front sleeve 16 is press fit to nut 22 to rotationally and axially secure the sleeve to the nut. The press fitting of nose piece 18 to body nose section 24 also helps to retain sleeve 16 against forward axial movement. Nose piece 18 may be coated with a non-ferrous metallic coating to prevent rust and to enhance its appearance. Examples of suitable coatings include zinc or nickel, although it should be appreciated that any suitable coating could be utilized.

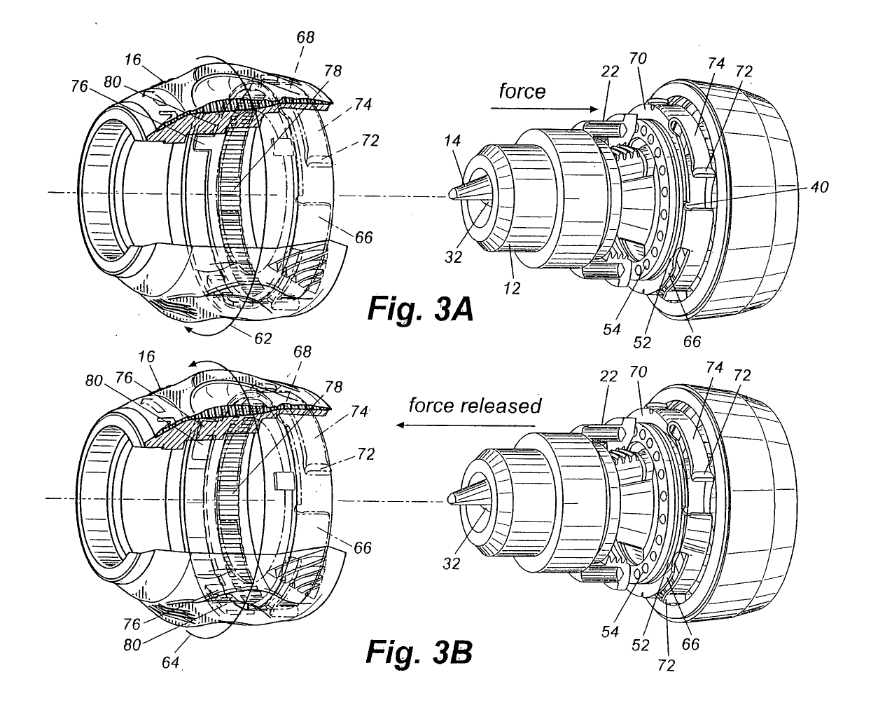

Because sleeve 16 is rotationally fixed to nut 22, the sleeve's rotation with respect to body 12 also rotates nut 22 with respect to the body, which moves jaws 14 axially within passageways 32 due to the engagement of jaw threads 38 and nut threads 48. The direction of axial movement of jaws 14 depends on the rotational direction of sleeve 16 and nut 22 with respect to body 12. If a tool, such as a drill bit, is inserted into bore 28, the sleeve and nut may be rotated about chuck axis 34 in a closing direction 62 (FIG. 3A) so that jaws 14 move to a closed position wherein jaw tool engaging surfaces 36 grippingly engage the tool. Rotation of sleeve 16 and nut 22 about axis 34 in the opposite or opening direction 64 (FIG. 3B) moves the jaws axially rearward out of the closed position to an open position as illustrated in FIG. 2.

Chuck 10 includes a tightening torque indicator comprising an annular ring 66 and an annular ratchet 68. Annular ring 66 defines an inwardly extending flange 70 (FIG. 1) and has pawls 72 that are connected to the ring via spring tabs 74. Spring tabs 74 bias the pawls radially outward from chuck axis 34 into engagement with annular ratchet 68. Annular ratchet 68 defines forwardly extending tabs 76 and a plurality of teeth 78 formed on an inner circumference of the main ratchet band. Each of teeth 78 has a first side with a slope approaching 90 degrees and a second side having a lesser slope, which allows pawls 72 to slip over the teeth in one direction but not in the opposite direction.

Annular ring 66 is received on chuck body 12 intermediate bearing washer 52 and thrust ring 40. Annular ratchet 68 is received about annular ring 66 and nut 22 so that grooves 80 (FIGS. 3A and 3B) formed on the inner circumference of sleeve 16 receive respective tabs 76. The width of grooves 80 is larger than the width of tabs 76 so that sleeve 16 is rotatable over a limited angular distance relative to annular ratchet 68.

To close the chuck from an open condition, and referring to FIG. 3A, nut 22 is rotated via sleeve 16 in closing direction 62 so that jaws 14 are threadedly moved axially forward within passageways 32. Because tabs 76 sit against the driving edges of grooves 80, annular ratchet 68 rotates in conjunction with sleeve 16. Annular ring 66 also rotates with sleeve 16 since pawls 72 rotationally fix annular ring 66 to annular ratchet 68. Once jaws 14 clamp onto a tool shank, however, axial force is increasingly exerted rearwardly through jaws 14 to nut 22. The rearward axial force is transmitted through nut 22 to chuck body 12, and in particular against thrust ring member 40. Because annular ring flange 70 is intermediate bearing washer 52 and thrust ring ledge 44 (FIG. 1), axial force is transmitted from nut 22 through annular ring flange 70 to thrust ring member 40. This increases frictional forces between annular ring flange 70, thrust ring washer 52 and thrust ring member 40 in a direction opposite to the direction that sleeve 16 and nut 22 are being rotated. Accordingly, the frictional forces restrain rotation of annular ring 66 with respect to body 12. Bearing 54, however, permits sleeve 16 and nut 22 to continue to rotate relative to chuck body 12 and annular ring 66 in the closing direction. Additionally, since pawls 72 are deflectable and are generally disposed in alignment with the shallow slopes of the second side of teeth 78, annular ratchet 68 continues to rotate with sleeve 16 relative to annular ring 66. Thus, as annular ratchet 68 rotates, the distal ends of pawls 72 repeatedly ride over teeth 78, producing an audible clicking sound as the pawl ends fall against each subsequent tooth's second side. Pawls 72 are generally perpendicular to the first sides of teeth 78 and do not deflect inward to permit rotation of annular ratchet 68 in a direction opposite to 62. In summary, until the jaws clamp onto a tool shank, annular ring 66 rotates with annular ratchet 68. Once the jaws clamp onto a tool shank, annular ratchet 68 rotates in the closing direction relative to annular ring 66 but is blocked from rotating in opening direction 64.

To open chuck 10, and referring particularly to FIG. 3B, sleeve 16, and therefore nut 22, are rotated in direction 64 opposite to direction 62. Because pawls 72 and ratchet teeth 78 constrain annular ratchet 68 in the opening direction, annular ratchet 68 initially does not move, and tabs 76 therefore move through grooves 80 as sleeve 16 rotates. This slight rotation of nut 22 relative to chuck body 12 causes jaws 14 to retract slightly in passageways 32 and thereby releases the axially rearward force that frictionally retains annular ring flange 70 between bearing washer 52 and thrust ring member 40 (FIGS. 1 and 2). As a result, annular ring 66 is once again rotatable with respect to the body. As the user continues to rotate sleeve 16 in opening direction 64, tabs 76 abut the sides of grooves 80 so that sleeve 16 again drives annular ratchet 68 and annular ring 66.

Depending on the frictional engagement between sleeve 16 and ratchet ring 68, if sleeve 16 is thereafter rotated in the closing direction, tabs 76 may rotate through grooves 80 until the tabs abut the opposite sides of the grooves, and the chuck may then be operated in the closing direction as described above. In the presently illustrated embodiment, however, friction between sleeve 16 and ring 68 hold the sleeve and the ring together in the position shown in FIG. 3B as the sleeve is rotated in closing direction 62 (FIG. 3A) until the jaws close onto a tool shank. When this event stops rotation of ring 68, pawls 72 hold ratchet ring 68 in position until grooves 80 in the still-rotating sleeve 16 pass over tabs 76. When the following edges of grooves 80 engage tabs 76, the sleeve again drives ring 68, and the chuck operates as discussed above.

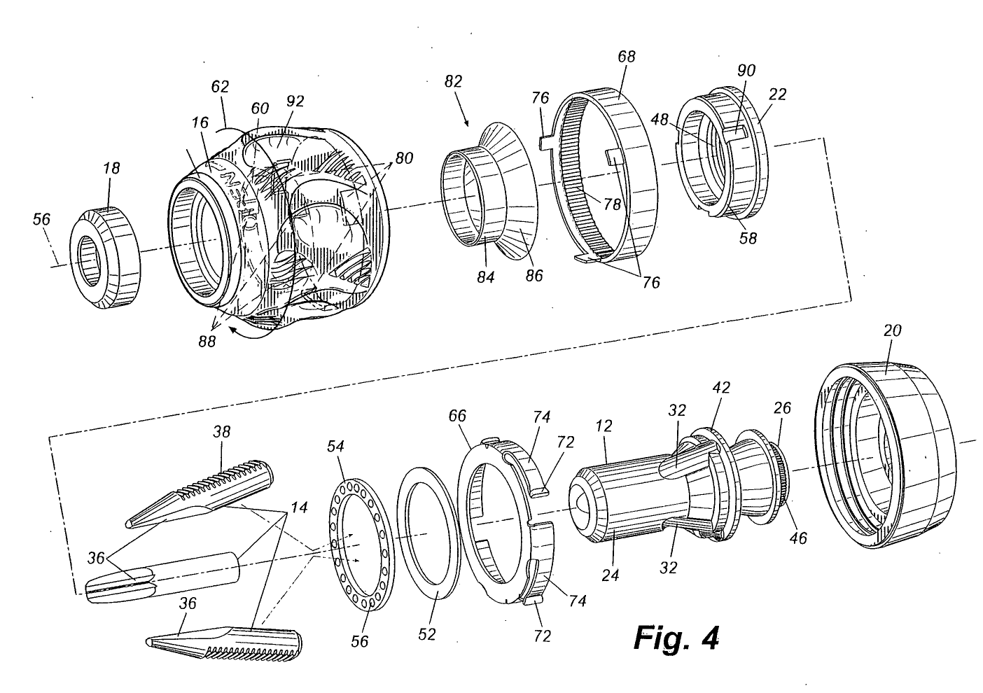

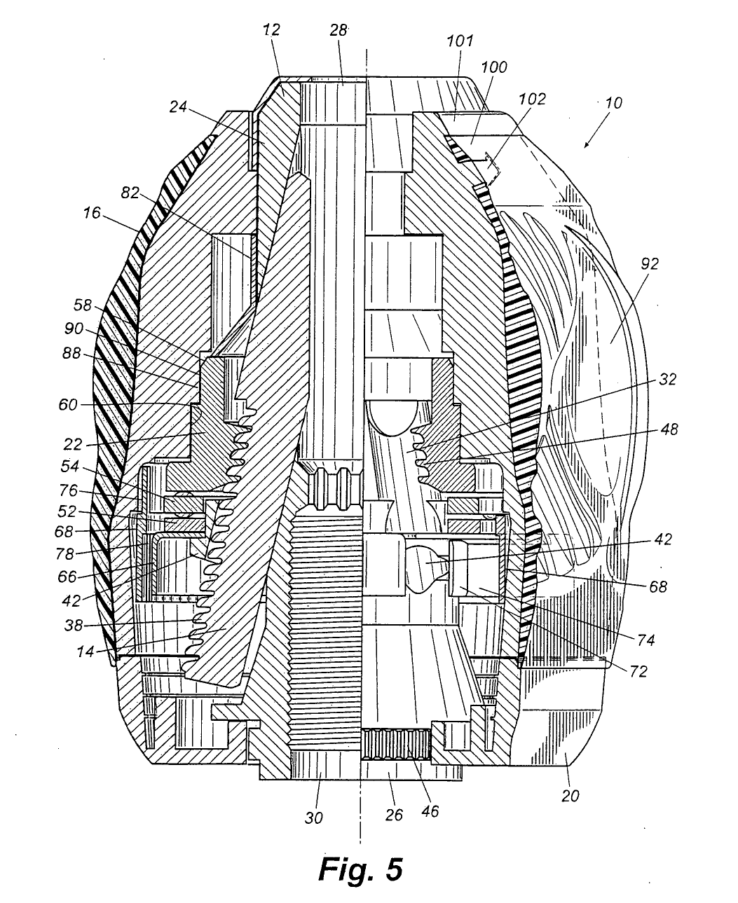

In the embodiment illustrated in FIG. 4, chuck body 12 has been modified to receive a one piece nut 22. Forward portion 24 of chuck body 12 has been narrowed to allow the one-piece nut to slip over the forward body section into operative engagement with jaws 14 and thrust ring 42. That is, in assembling the chuck of FIGS. 4 and 5, annular ring 66, bearing washer 52 and bearing retainer 54 are slipped onto chuck body 12 adjacent to thrust ring 42. Next, jaws 14 are placed into respective passageways 32, and one-piece nut 22 is placed into abutment with bearings 56, so that the nut threads are in meshing engagement with the jaw threads.

A nut retainer 82 is received over forward body portion 24 in abutment with nut 22 to retain the nut in the axially forward direction. Nut retainer 82 includes a first generally cylindrical portion 84 that is press-fit onto the body and a second frusto-conical portion 86 that engages the nut while providing clearance for the jaws forward of the nut. Annular ratchet 68 is received about annular ring 66 so that pawls 72 engage teeth 78. Front sleeve 16 is then loosely fitted over forward body section 24. Drive ribs 88 (shown in phantom in FIG. 4) formed on the inner circumference of front sleeve 16 engage drive slots 90 of nut 22, and annular ratchet tabs 76 are received in grooves 80 so that front sleeve 16, nut 22 and toothed ring 68 operate as described above.

A nose piece 18 is dimensioned and adapted to be press-fitted onto the front of forward body section 24 to maintain front sleeve 16 on chuck 10. It should be appreciated that nose piece 18 could also be secured by snap fit, threading, or the like. Nose piece 18 is exposed when the chuck is assembled and is preferably coated with a non-ferrous metallic coating to prevent rust and to enhance its appearance. In a preferred embodiment, such coating may be zinc or nickel; however, it should be appreciated that any suitable coating could be utilized.

Nose piece 18 serves to maintain front sleeve 16 in position on chuck body 10 and in driving engagement with nut 22. In addition, nose piece 18 serves the dual purpose of providing an aesthetically pleasing cover for the nose portion that inhibits rust. This provides the advantage of an aesthetically pleasing appearance without the necessity to coat the entire chuck body 12 with a non-ferrous material.

The chuck of FIGS. 4 and 5 operates substantially the same as the embodiment of FIGS. 1 to 3. Therefore, a discussion of the operation of the chuck and tightening indicator will not be repeated.

The outer circumferential surface of front sleeve 16 in FIGS. 1-5 may be provided with raised portions 92 to enable the operator to grip the sleeve securely. Lobes 92 are disposed angularly about the circumference of sleeve 16 to form ergonomic gripping points for the user, while the respective areas between lobes 92 form slight depressions to receive portions of the user's fingers and other pressure-applying portions of the hand so that those portions of the hand fit naturally against the sides of lobes 92 when the user grips the sleeve. The lobes thereby facilitate the hand's mechanical advantage to the sleeve, and it is believed the user can apply a tightening or loosening torque greater than would be applied to a smooth-surfaced chuck sleeve of comparable dimensions. At the same time, and as described in more detail below, the sleeve's outer skin gives slightly in response to pressure applied by the user's hand, thereby providing a softer grip and facilitating the user's grip on the sleeve. In the embodiment illustrated in the figures, lobes 92 extend generally axially along the sleeve's outer surface and bow tangentially in the chuck's opening direction. The highest point in each lobe (in the radial direction) is at the apex of the bow. Depending on the user's grip, the principal pressure points in the user's grip can generally be expected to occur at these points. It should be understood, however, that the outer skin's spatial configuration can vary as desired and that the arrangements shown in the figures is provided for exemplary purposes only.

The circumferential surface of rear ring 20 may be knurled or left smooth as shown in the figures. In one preferred embodiment, a resilient polymer is provided on the outer surface of rear ring 20 as on front sleeve 16.

Preferably, the front sleeves of the chucks shown in FIGS. 1-5 are comprised of a rigid polymer inner core of a structural plastic such as a polycarbonate, a filled polypropylene, e.g., glass-filled polypropylene, a nylon or polyamide material, or a blend of structural plastic materials and a resilient polymer outer skin of a thermoplastic elastomer (TPE), a thermoplastic rubber (TPR), or other suitable material adhered to the inner core by a double injection molding process.

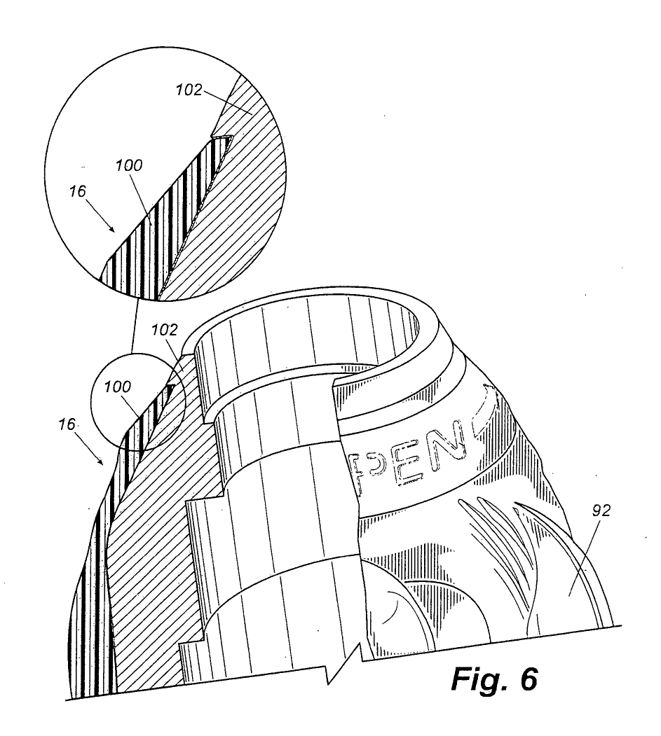

Referring to FIG. 5, double injection molding allows for sleeve designs that are not achievable with single polymer molds. For example, the inner core material (101) that is different from outer skin (100) can be molded so that a portion of the inner core protrudes through outer skin 100 to form indicia on the chuck sleeve surface. The indicia can be, for example, directions for opening or closing the chuck (as indicated by the “open” and arrow indicia in phantom in FIG. 6 and at 102 in FIG. 5), private labels for branding the chuck or other useful indicia. Furthermore, the inner core can extend forward of the outer skin so that the inner core itself defines a portion of the outer sleeve, as shown at 101, to provide protection to the outer skin. That is, the portion of the core material at 101 forms a front edge of sleeve 16 that protects the softer outer skin material from abrasion in the event the user drives the chuck into a workpiece having a protruding surface that impacts the front of the chuck sleeve.

“Adhesion,” as used herein, of the outer skin to the inner core refers to the direct commingling of the adjacent outer skin and inner core materials, as opposed to a bonding that relies solely or primarily upon an intermediate adhesive between the materials of the outer skin and the inner core. Referring to FIG. 6, for example, adhesion of the illustrated inner core and outer skin is caused by commingling of the component materials driven by thermal energy of a double injection molding process, free of an intermediate chemical adhesive. As schematically represented in FIG. 6, sections of neighboring macromolecules penetrate into each other.

TPEs and TPRs are materials having characteristics generally between those of thermoplastic polymers and rubber elastomers in that TPEs and TPRs melt with the application of heat similarly to thermoplastics but act like elastomers once cooled. In contrast to chemical cross-linking seen in elastomers, TPEs and TPRs involve purely physical cross-linking that can be reversed when heat is reapplied to the material. As a result, TPEs and TPRs (1) are free-flowing and shapeable under application of heat and force, (2) solidify when cooled, and (3) adhere to a diverse number of thermoplastics, making them favorable materials for double injection molding with structural polymers. TPEs and TPRs are, furthermore, generally easily colorable and recyclable.

One major descriptive characteristic of TPEs and TPRs is their value of hardness. “Hardness,” as used herein, is a measure of the resistance of a cured material to withstand indention. Hardness may be measured by a durometer. As should be understood in this art, a durometer measures penetration depth into a material of a pin or drill applied to a surface of the material with a controlled, measured force. As should also be understood, hardness may be expressed in various scales, for example a Shore A scale for soft materials and a Shore D scale for harder materials.

A Shore A durometer is used to measure the hardness of rubber parts by measuring the resistance force against a pin that penetrates the test material under a known spring load. The amount of penetration is converted to a hardness reading on a scale having 100 Shore A units. Similarly, Shore D durometer is used to measure the hardness of plastic parts. The indentation hardness is inversely related to the penetration and is dependent on the modulus of elasticity and the viscoelastic properties of the material. The force applied, the shape of the indenter, and the duration of the test affect the results. The Shore durometer consists of a reference presser foot, an indenter, an indicating device, and a calibrated spring that applies the force to the indenter. The difference between the type A and type D durometer is in the shape of the indenter and the calibrated spring, as indicated in the table below.

| Shore Durometer | Indenter | Applied force, F/mN |
|---|---|---|
| Type A | Hardened steel rod having a | F = 550 + 75 H_{A} |
| | 1.10 mm-1.14 mm diameter, | |
| | with a truncated 35° | |
| | cone, 0.79 mm diameter. | |
| Type D | Hardened steel rod having a | F = 445 H_{D} |
| | 1.10 mm-1.14 mm diameter, | |
| | with a 30° conical point, | |
| | 0.79 mm diameter. | |

The units of hardness range from 0 for the full protrusion of the 2.50 mm indenter to 100 for no protrusion. The force is applied as rapidly as possible, without shock, and the hardness reading made after a duration of 15s±1s. If an instantaneous reading is specified, the scale is read within 1s of the application of force.

Shore hardness can have values down to a very soft material at Shore A 20 and increasing in hardness through Shore A 90 into Shore D 30 up to Shore D 85, which is very hard. For example, a typical pencil eraser has a Shore A hardness generally within a range of 25-30. A rubber sole of a shoe can be expected to have a shore A hardness generally within a range of 75-85 and a Shore D hardness generally within a rang of 25-30. Referring again to FIG. 5, inner core 101 preferably has a hardness within a range of about 35 to 80 Shore D units, and in one preferred embodiment has a hardness within a range of about 50 to 60 Shore D units. Outer skin 100 preferably has a hardness less than about 80 Shore A units, and in one preferred embodiment has a hardness within a range of about 40 to 50 Shore A units.

Referring again to FIGS. 1, 4 and 6, laminate sleeve 16 is formed by a double injection process that involves forcing melted polymers into a mold cavity. Once cooled, the molded part is ejected. In general, there are six major steps in an exemplary double injection molding process of a two-polymer part:
1. Clamping: A mold is held under pressure during injection and cooling.
2. Injection: The two polymers are heated until molten. The molten polymers are pushed into the mold at a predetermined time in a two-shot process described below.
3. Dwelling: The injection process pauses while pressure is applied to make sure all of the mold cavities are filled.
4. Cooling: The polymers are allowed to cool to their solid form within the mold.
5. Mold Opening: The mold components separate.
6. Ejection: The finished piece is ejected from the mold.

A double injection molding process produces a chuck sleeve as described herein comprising an inner core and outer skin of different types of polymers adhered to each other, and “double injection molding” as use herein refers to the molding of two or more different polymers such that the different polymers come together at sufficient temperature in the molding process that adhesion occurs. The polymers can have different coloration, but be otherwise identical, or can be materials otherwise having different chemical compositions. The different polymers must be compatible in the sense that adhesion occurs at elevated temperature. If the different polymers are not compatible, they will not adhere to each other and may therefore delaminate at the interface between the two polymer layers.

A preferred double injection molding method for forming sleeve 16 has a two-shot injection process, in which the generally cylindrical inner core is first molded from rigid polymer and the tool is then manipulated to accept injection of a second material around, over, under, or through the inner core to complete the final product. For example, polymer material may be injected into the mold in the first shot to form the inner core. When the first material cools sufficiently to manipulate the tool without deforming the sleeve inner core, but before the inner core cures to the point it has a mature skin that will not adhere to the TPE or TPR outer skin (the intermediate cooling point), the tool opens to create an additional cavity space that is then filled by the TPE or TPR outer skin material to complete the sleeve. Machinery suitable for making two-shot molded components as discussed herein is available from Multiplas International Inc., of Newburgh, N.Y.

Compatibility of the different materials is generally required to promote adhesion and to prevent delamination and part failure. Downstream assembly operations may be eliminated, and time and expense are reduced if mechanical fasteners or chemical adhesives do not have to be purchased, installed, or applied. Furthermore, adhesion of the two materials without chemical adhesives results in stronger, long lasting parts.

The two-shot molding procedure is particularly preferred to produce a sleeve as shown in FIGS. 1-5 in that it is particularly suited to the formation of an inner core having outer surface details different from those of the outer skin and, if desired, extending through the outer skin. Thus, for example, the inner core may be initially molded so that it defines raised lettering or other indicia (for example, the “open” and arrow indicia shown in FIG. 6 in phantom and indicated at 102 in FIG. 5) on the surface of a generally cylindrical main portion, as shown in cross section in FIG. 5. The second mold arrangement is configured such that in the second stage, the raised indicia abut the mold's inner surface. When the outer skin TPE or TPR is injected into the mold in the second shot, the outer skin material flows about the outer surface of the inner core except for the outer surface of the raised indicia. Thus, when the part is removed from the mold, the inner core's raised indicia are visible through the outer skin.

Moreover, the second mold maybe configured to define raised portions of the resilient outer skin (for example at lobes 92 in FIG. 1), with adjacent intermediate areas having a lower height than the raised portions, so that the raised portions thereby define points on the sleeve that primarily receive pressure from the user's grip. The shapes and dispositions of the raised portions and adjacent troughs can vary as desired, for example for aesthetic purposes, but can also be chosen so that those portions of the user's hand (for example the upper palm) that primarily apply rotational force to the sleeve align with and engage one or more raised portions in the force-applying direction. For example, the generally axially aligned lobes 92 in FIG. 1 generally align with the user's upper palm when the hand grips the sleeve. Thus, the lobes facilitate the user's grip at the point where the upper palm engages one of the lobes while simultaneously providing a resilient pressure point to soften the sleeve's feel to the user's hand. The remaining lobes similarly provide resilient pressure points to the lower palm and fingers. Thus, the shape of the outer mold may be varied as desired to selectively dispose the resilient outer skin material to define the raised portions and troughs both to present an aesthetically pleasing sleeve and to define resilient pressure points that enhance and soften the user's grip.

Finally, the inner core and outer skin may be made from respective colors (for example black and red, black and orange, or red and green) that are sufficiently different so as to be distinguishable by the human eye.

It should be appreciated by those skilled in the art that various modifications and variations can be made in the present invention without departing from the scope and spirit of the invention. It is intended that the present invention cover such modifications and variations as come within the scope and spirit of the appended claims and their equivalents.

What is claimed is:

1. A method of manufacturing a chuck for use with a manual or powered driver having a rotatable drive shaft, the method comprising the steps of:
a. providing
(i) a body having a nose section and a tail section, the tail section being configured to matingly attach to the drive shaft for rotation therewith, and the nose section having an axial bore formed therein and a plurality of angularly disposed passageways formed therethrough and intersecting the axial bore,
(ii) a plurality of jaws, each of the jaws slidably positioned in a respective one of the angularly disposed passageways,
(iii) a nut coupled to the jaws such that rotational movement of the nut with respect to the body causes the jaws to move toward or away from the axial bore depending on the direction of rotational movement;
b. molding a generally cylindrical inner core from a rigid polymer;
c. molding, about an outer circumferential surface of the inner core, an outer skin from a resilient polymer so that material comprising the outer skin commingles with material comprising the inner core, wherein the outer skin has a radial thickness, and wherein the molding step (c) includes varying the radial thickness of the outer skin according to a predetermined pattern; and
d. disposing the inner core about the body in operative engagement with the nut so that the outer skin defines an outer gripping surface of the chuck and so that rotation of the inner core with respect to the body causes the jaws to reciprocate relative to the body.

2. The method of manufacturing a chuck for use with a manual or powered driver having a rotatable drive shaft of claim 1, wherein molding step (b) further comprises varying a radial thickness of the inner core so that a predetermined portion of the inner core extends radially outward of a generally cylindrical main portion of the inner core.

3. The method of manufacturing a chuck for use with a manual or powered driver having a rotatable drive shaft of claim 2, wherein molding step (c) includes defining the radial thickness of the outer skin so that the predetermined portion extends through the outer skin and is visible at an outer surface of the chuck.

4. The method of manufacturing a chuck for use with a manual or powered driver having a rotatable drive shaft of claim 1, wherein molding step (c) includes molding the resilient polymer outer skin from a material chosen from the group consisting of thermoplastic elastomers and thermoplastic rubbers.

5. A method of manufacturing a chuck for use with a manual or powered driver having a rotatable drive shaft, the method comprising the steps of:
a. providing
(i) a body having a nose section and a tail section, the tail section being configured to matingly attach to the drive shaft for rotation therewith, and the nose section having an axial bore formed therein and a plurality of angularly disposed passageways formed therethrough and intersecting the axial bore,
(ii) a plurality of jaws, each of the jaws slidably positioned in a respective one of the angularly disposed passageways,
(iii) a nut coupled to the jaws such that rotational movement of the nut with respect to the body causes the jaws to move toward or away from the axial bore depending on the direction of the rotational movement;
b. molding a generally cylindrical rigid polymer inner core having an axial first end and an axial second end;
c. molding, about an outer circumferential surface of the inner core rearward of the inner core first end, a resilient polymer outer skin so that material comprising the outer skin commingles with material of the inner core and so that a portion of the outer circumferential surface of the inner core adjacent the first end is not covered by the outer skin; and
d. disposing the inner core about the body in operative engagement with the nut so that the outer skin defines an outer gripping surface of the chuck and so that rotation of the inner core with respect to the body causes the jaws to reciprocate relative to the body.

6. The method of manufacturing a chuck for use with a manual or powered driver having a rotatable drive shaft of claim 5, wherein the resilient polymer outer skin has a radial thickness and wherein molding step (c) includes varying the radial thickness of the resilient polymer outer skin according to a predetermined pattern.

7. The method of manufacturing a chuck for use with a manual or powered driver having a rotatable drive shaft of claim 5, wherein molding step (b) further comprises varying a radial thickness of the inner core so that a predetermined portion of the inner core extends radially outward of a generally cylindrical main portion of the inner core, and wherein molding step (c) includes defining a radial thickness of the outer skin so that the predetermined portion extends through the outer skin and is visible at an outer surface of the chuck.

8. The method of manufacturing a chuck for use with a manual or powered driver having a rotatable drive shaft of claim 5, wherein molding step (c) includes molding the resilient polymer outer skin from a material chosen from the group consisting of thermoplastic elastomers and thermoplastic rubbers.

9. A method of manufacturing a chuck for use with a manual or powered driver having a rotatable drive shaft, the method comprising the steps of:
a. providing
(i) a body having a nose section and a tail section, the tail section being configured to matingly attach to the drive shaft for rotation therewith, and the nose section having an axial bore formed therein and a plurality of angularly disposed passageways formed therethrough and intersecting the axial bore,
(ii) a plurality of jaws, each of the jaws slidably positioned in a respective one of the angularly disposed passageways,
(iii) a nut coupled to the jaws such that one of axial and rotational movement of the nut with respect to the body causes the jaws to move toward or away from the axial bore depending on the direction of movement;
b. molding a generally cylindrical rigid polymer inner core having an outer circumferential surface and at least one predetermined raised portion extending therefrom;
c. molding, about the outer circumferential surface of the inner core, a resilient polymer outer skin so that the resilient polymer outer skin covers the outer circumferential surface but does not cover the predetermined raised portion; and
d. disposing the inner core about the body in operative engagement with the nut so that the outer skin defines an outer gripping surface of the chuck and so that rotation of the inner core with respect to the body causes the jaws to reciprocate relative to the body.

10. A method of manufacturing a chuck for use with a manual or powered driver having a rotatable drive shaft, the method comprising the steps of:
a. providing
(i) a body having a nose section and a tail section, the tail section being configured to matingly attach to the drive shaft for rotation therewith, and the nose section having an axial bore formed therein and a plurality of angularly disposed passageways formed therethrough and intersecting the axial bore,
(ii) a plurality of jaws, each of the jaws slidably positioned in a respective one of the angularly disposed passageways,
(iii) a nut coupled to the jaws such that rotational movement of the nut with respect to the body causes the jaws to move toward or away from the axial bore depending on the direction of rotational movement;
b. double injection molding
(i) a generally cylindrical inner core from a rigid polymer with
(ii) an outer skin from a resilient polymer, wherein the outer skin is molded about an outer circumferential surface of the inner core; and
c. disposing the inner core about the body in operative engagement with the nut so that the outer skin defines an outer gripping surface of the chuck and so that rotation of the inner core with respect to the body causes the jaws to reciprocate relative to the body.
